(19) United States
(12) Patent Application Publication
(10) Pub. No.: US 2025/0111560 A1
(43) Pub. Date: Apr. 3, 2025

(54) METHODS AND APPARATUS TO MODIFY USER INTERFACES USING ARTIFICIAL INTELLIGENCE

(71) Applicant: Fisher-Rosemount Systems, Inc., Round Rock, TX (US)

(72) Inventors: Mark Nixon, Thorndale, TX (US); Curtis Thompson, Austin, TX (US)

(21) Appl. No.: 18/901,730

(22) Filed: Sep. 30, 2024

Related U.S. Application Data
(60) Provisional application No. 63/587,411, filed on Oct. 2, 2023.

(51) Int. Cl. G06T 11/20; G06T 7/00

(52) U.S. Cl. CPC G06T 11/206; G06T 7/0002; G06T 2200/24; G06T 2207/20072; G06T 2207/30168

(57) ABSTRACT

Methods and apparatus to modify user interfaces using artificial intelligence are disclosed. An example apparatus comprises instructions access first image data corresponding to a first diagram representing a process control system, the first diagram to be displayed via a user interface of the process control system, the first diagram including a first feature having a first visual characteristic and a second feature having a second visual characteristic, determine a first visual perception score associated with the first feature and a second visual perception score associated with the second feature, determine a third visual characteristic for the first feature, the third visual characteristic to increase the first visual perception score, generate second image data corresponding to the second diagram including the first and second features, the first feature having the third visual characteristic and the second feature having the second visual characteristic, and display the second diagram via the user interface.

### RELATED APPLICATION

This patent claims the benefit of U.S. Provisional Patent Application No. 63/587,411, which was filed on Oct. 2, 2023. U.S. Provisional Patent Application No. 63/587,411 is hereby incorporated herein by reference in its entirety. Priority to U.S. Provisional Patent Application No. 63/587,411 is hereby claimed.

### FIELD OF THE DISCLOSURE

This disclosure relates generally to user interfaces and, more particularly, to methods and apparatus to modify user interfaces using artificial intelligence.

### BACKGROUND

Process control systems, like those used in chemical, oil refining or other processes, typically include one or more process controllers or devices communicatively coupled to an operator workstation and one or more field devices. These controllers can receive signals indicative of process measurements made by the field devices and generate control signals based on those measurements. Information from the field devices and the controllers may be made available to one or more user interface applications and visually presented to a user via an operator workstation.

### BRIEF DESCRIPTION OF THE DRAWINGS

FIG. 1 is a block diagram of an example process control environment in which an example interface circuitry operates to modify an example user interface.

FIG. 2 is a block diagram of an example implementation of the interface circuitry of FIG. 1.

FIGS. 3A-3F illustrate example visual characteristics that can be detected in example user interfaces disclosed herein.

FIGS. 4A-6H illustrate example diagrams that can be implemented in accordance with teachings disclosed herein.

FIG. 7 is a flowchart representative of example machine readable instructions and/or example operations that may be executed, instantiated, and/or performed by example programmable circuitry to implement the interface circuitry of FIG. 2.

FIG. 8 is a block diagram of an example processing platform including programmable circuitry structured to execute, instantiate, and/or perform the example machine readable instructions and/or perform the example operations of FIG. 7 to implement the interface circuitry 102 of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A process control system can include a plurality of field devices that provide different functional capabilities and which are typically communicatively coupled to process controllers. In some examples, data (e.g., operating condition data) associated with such process control systems can be displayed as graphics within a user interface (UI). The graphics may include charts, graphs, diagrams, pictures, tables, connectors, etc. In some examples, the graphics can provide a numerical and/or pictorial representation of the data that operators, engineers and/or other process control personnel use to monitor, control and evaluate the performance of a process control system. UIs enable an operator to access an abundance of system information, but there are limitations to human attention and mental workload. Operators can often face multiple notifications and alarms associated with the system and/or one or more of the field devices at any given moment. When UIs are crowded and disorganized, it becomes more difficult for an operator to recognize when alarms are indicating abnormal process conditions. As such, there is a risk of system failure and field device damage when the UI is cluttered and congested with unnecessary information and/or otherwise prevents a quick assessment of key operating features of the process control system.

Examples disclosed herein employ Artificial Intelligence (AI)/Machine Learning (ML) models to categorize key (e.g., relevant, salient, etc.) features (e.g., feature vectors) of an example image (e.g., a process diagram) displayed on a user interface of a process control system. Examples disclosed herein monitor and/or otherwise process one or more images to be displayed via a user interface to distinguish key features (e.g., alarms) from accessory features (e.g., clutter, redundant information, etc.) and, subsequently, generate one or more modified images (e.g., system diagrams) that visually emphasizes the key features to which an operator's attention is to be drawn. As such, examples disclosed herein provide an operator of a UI of the process control system with a straightforward representation of the process control system. Further, examples disclosed herein enable an operator to promptly respond to system abnormalities and alarms.

In some examples described herein, the data associated with one or more images associated with a process control system and to be displayed via a user interface is processed and modified prior to runtime of the process control system. Such examples may be referred to as “static analyses,” “static algorithms,” etc. In these examples, the images are modified to enhance or increase an operator's visual perception of one or more key features of the displayed images, thereby more readily drawing the operator's attention to these key features. Such key features may correspond to critical operating features (e.g., devices, values, etc.) of the process control system as determined or defined by the operator and/or in other manners. To determine the manner in which the images are to be modified, a visual saliency algorithm may be employed to associate a visual perception score or weight to each of the key features of the images being processed. As used herein, “visual saliency” refers to a subjective perceptual quality that makes some items in data (e.g., image data, display data, etc.) stand out from neighboring items. Additionally, a “visual perception score” as used herein corresponds to a numerical value or other data that represents a relative ranking of the visual distinctiveness of a key feature of a displayed image. In other words, a visual perception score corresponds to the relative ease with which a user or operator can visually detect a key feature among other features of a displayed image. The visual perception scores may then be evaluated to determine which, if any, of the visual perception scores are to be increased to thereby increase the visual detectability of the key features associated with those visual perception scores. In these examples, the visual perception scores may be increased by changing one or more visual characteristics of the portion of the image corresponding to the key features. For example, a shape, size, color, orientation, location, brightness (e.g., contrast), etc., of the portion of the image may be changed to increase the visual perception score. Further, a visual clutter analysis may be performed to determine which, if any, portions of the image may be eliminated to improve the visual perception scores of the key features. As used herein, “visual clutter” refers to excess items that, by their representation or organization, lead to a degradation of the performance of a given task.

In still other examples, the above-described processes for increasing visual perception scores of key features of images associated with a user interface of a process control system can be employed during runtime of the process control system. As such, these other examples may continuously monitor the images being displayed to a user or operator and process these images to detect and visually enhance (i.e., increase the visual perception scores) of key features identified in those images. In this manner, these examples continuously and automatically adapt display images of a process control system to ensure that an operator's attention is quickly and easily drawn to aspects of the process control environment that need their attention. Such examples that continuously and automatically monitor and modify UIs may be referred to as “dynamic analyses,” “dynamic algorithms,” etc.

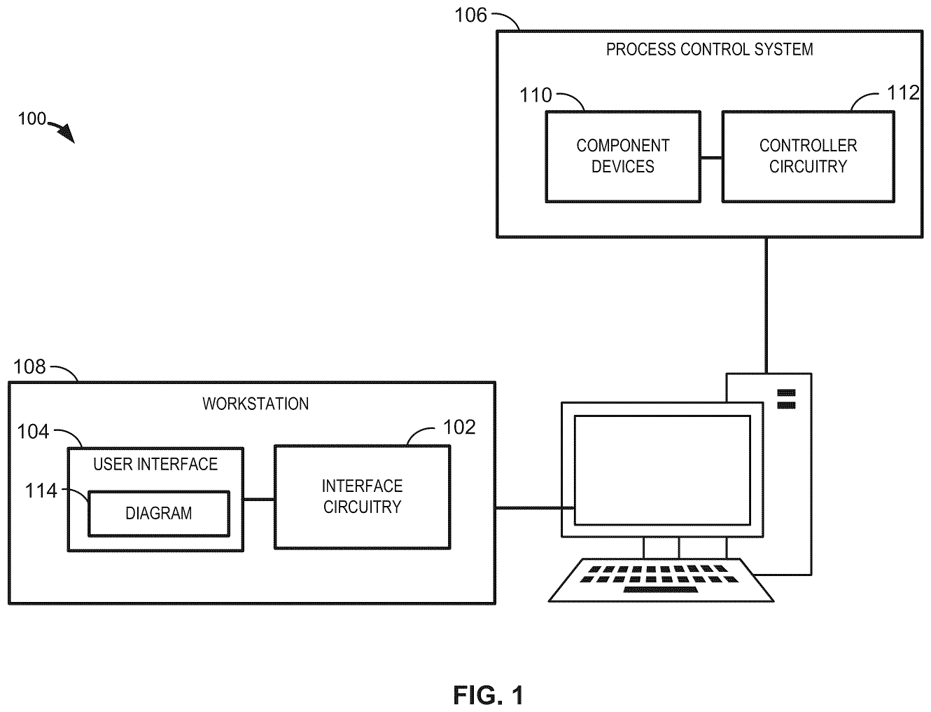

FIG. 1 is a block diagram of an example process control environment 100 in which example interface circuitry 102 operates to monitor and adjust an example user interface (UI) 104 associated with an example process control system 106. The example interface circuitry 102 may be implemented by and/or included within an example workstation 108. In other examples, the interface circuitry 102 may be included within a server, a distributed computing network, and/or any other computing device(s) that by be communicatively coupled to the workstation 108. The example process control system 106 may include any type of manufacturing facility, process facility, automation facility, and/or any other type of process control structure or system.

As shown in FIG. 1, the example process control system 106 includes example component devices (e.g., field devices, process control devices, etc.) 110. The example component devices 110 may include any type(s) of process control component(s) capable of receiving inputs, generating outputs, and/or controlling a process. For example, the component devices 110 may include valves, pumps, fans, heaters, coolers, strippers, tanks, drums, coalescers, separators, reactors, desalters, piping, etc., to control a process. Additionally, the component devices 110 may include measurement or monitoring devices such as temperature sensors, pressure sensors, concentration sensors, fluid level meters, flow meters, and/or vapor sensors to measure portions of a process. The example component devices 110 receive instructions from example controller circuitry 112 to execute specified operations and/or cause a change to the process implemented and/or controlled by the component devices 110. Further, the example component devices 110 measure process data, environmental data, and/or input device data and transmit the measured data to the controller circuitry 112 as process control information.

The example controller circuitry 112 transmits data to the workstation 108 at periodic or aperiodic intervals. For example, the controller circuitry 112 transmits data associated with outputs of the component devices 110 such as alarms, error messages, diagnostics, statistics, text, device identifiers, event notifications, etc. The example UI 104 allows an operator to review and/or operate the component devices 110, the controller circuitry 112, and the process control system 106 via the workstation 108. In this example, the interface circuitry 102 generates an example diagram 114 to organize and display data associated with the component devices 110, the controller circuitry 112, and the process control system 106.

The example workstation 108 may include any computing device such as a personal computer, a laptop, a server, etc. The example workstation 108 displays information pertaining to the process control system 106 via the UI 104. Additionally, the example UI 104 enables a user to manage the process control system 106 by providing graphical instrumentality (e.g., keyboard, pointer device, touchscreen, etc.) that the user may select and/or manipulate to cause the workstation 108 to send instructions to the controller circuitry 112. In some examples, the UI 104 may also be referred to as a console display or a human machine interface (HMI).

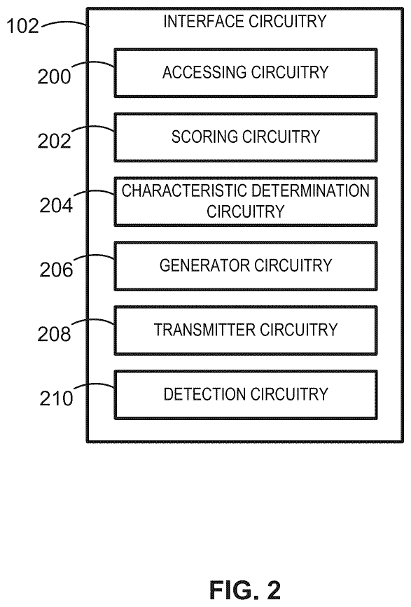

FIG. 2 is a block diagram of an example implementation of the interface circuitry 102 of FIG. 1 to modify an example UI. The example interface circuitry 102 includes example accessing circuitry 200, example scoring circuitry 202, example characteristic determination circuitry 204, example generator circuitry 206, example transmitter circuitry 208, and example detection circuitry 210. The interface circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the interface circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example accessing circuitry 200 accesses (e.g., obtains) first image data corresponding to a first example diagram representing an example process control system. For example, the example accessing circuitry 200 accesses example image data corresponding to the diagram 114 representing the process control system 106. The example accessing circuitry 200 accesses the diagram 114 via the workstation 108 (or other control device) operating in the process control system 106. In some examples, the accessing circuitry 200 can continuously monitor image data of the UI 104 during runtime of the process control system 106.

In some examples, the accessing circuitry 200 identifies key features of the monitored image data to be visually emphasized for a user or operator of the UI 104. For example, the image data can include a first key feature (e.g., a first one of the component devices 110) having a first visual characteristic and a second key feature (e.g., an output value associated with the first one of the component devices 110) having a second visual characteristic. In some examples, at least one of the key features corresponds to an alarm condition or a predetermined condition. As used herein, a “visual characteristic” describes an appearance of an example feature included in image data. For example, a visual characteristic of a feature can indicate a size of the example feature, a shape of the example feature, a color of the example feature, a position of the example feature, an orientation of the example feature, etc. In some examples, the accessing circuitry 200 can access features based on user inputs via the UI 104. In some examples, these user inputs may correspond to features of predetermined interest to the user.

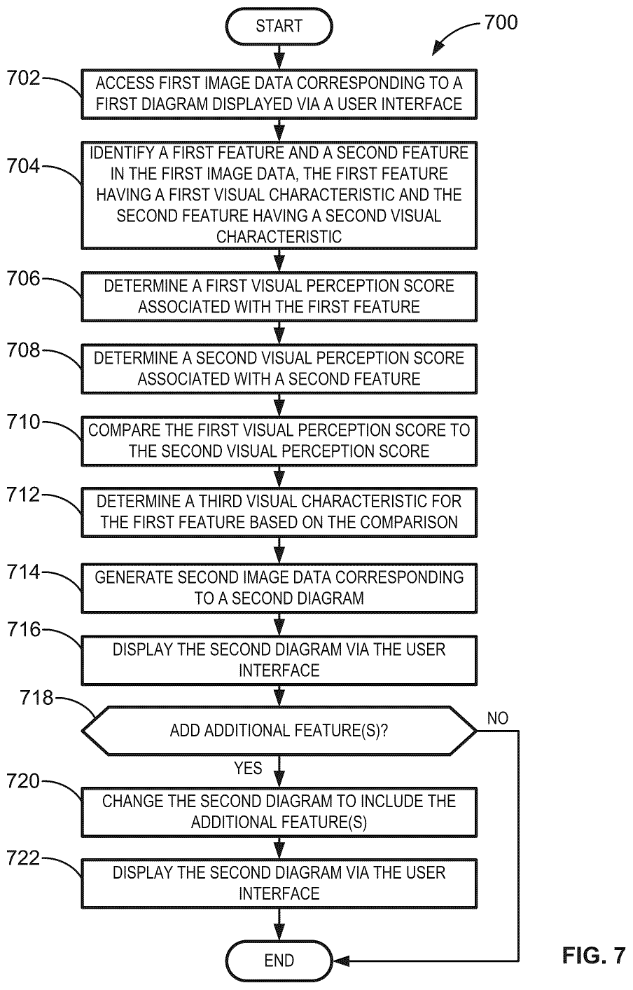

In some examples, the accessing circuitry 200 can determine identifying information associated with the features. For example, the accessing circuitry 200 can determine an operating condition such as normal operating conditions and/or abnormal operating conditions associated with an example feature. In other examples, the accessing circuitry 200 can determine alarm conditions (e.g., temperature limits of the component devices 110, pressure limits of the component devices 110, etc.) associated with the features. Further, the accessing circuitry 200 can identify changes in the operating conditions and/or alarm conditions associated with the features. For example, the accessing circuitry 200 can identify an activation of an alarm condition, a change in the normal operating condition, etc. In some examples, the accessing circuitry 200 is instantiated by programmable circuitry executing accessing instructions and/or configured to perform operations such as those represented by the flowchart of FIG. 7.

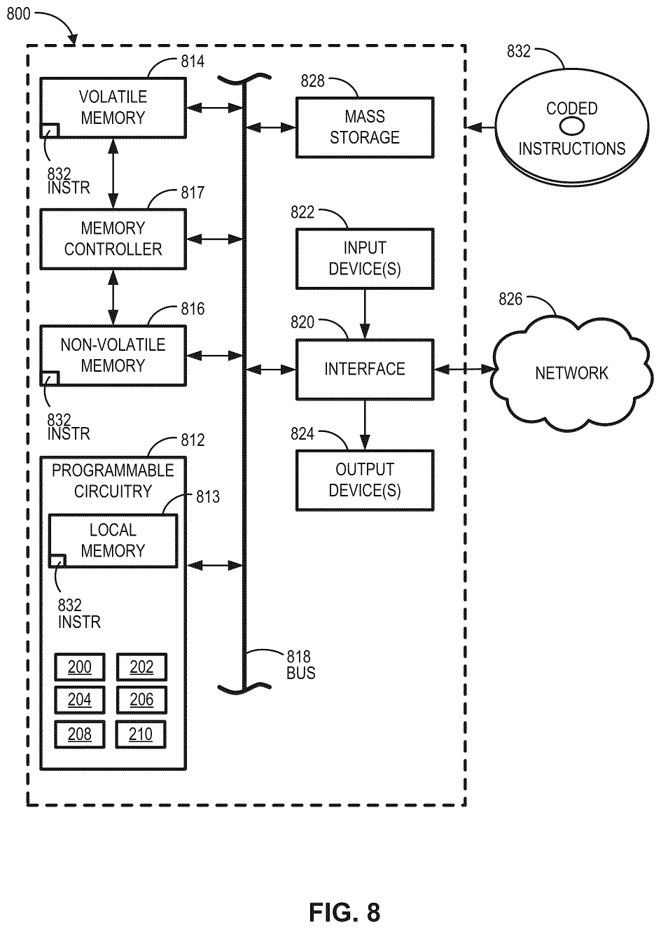

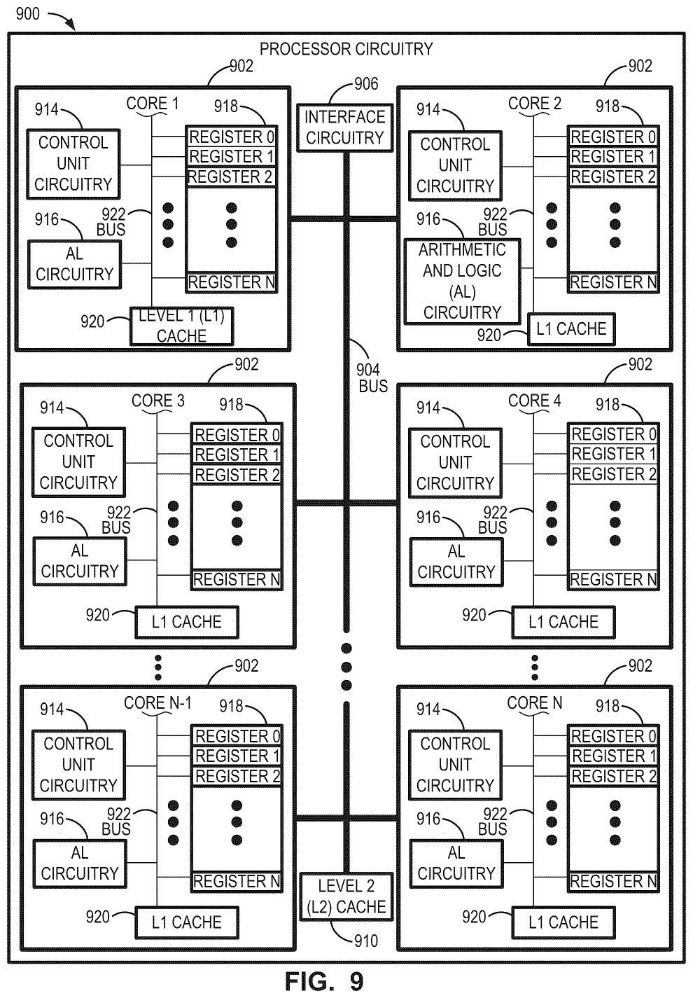

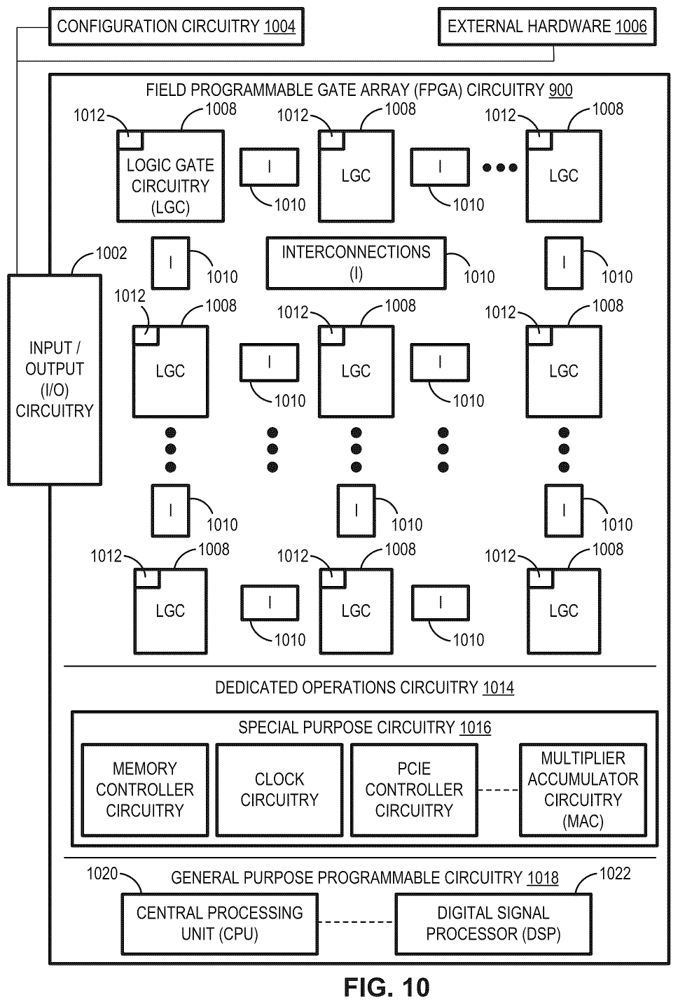

In some examples, the interface circuitry 102 includes means for accessing image data. For example, the means for accessing may be implemented by accessing circuitry 200. In some examples, the accessing circuitry 200 may be instantiated by programmable circuitry such as the example programmable circuitry 812 of FIG. 8. For instance, the accessing circuitry 200 may be instantiated by the example microprocessor 900 of FIG. 9 executing machine executable instructions such as those implemented by at least blocks 702, 704 of FIG. 7. In some examples, the accessing circuitry 200 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the accessing circuitry 200 may be instantiated by any other combination of hardware, software, and/or firmware. For example, the accessing circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example scoring circuitry 202 processes the first image data to determine visual perception scores associated with the features in the example diagram. For example, the scoring circuitry 202 may be communicatively coupled to an example AI/ML model configured and trained to extract key features from the first image data. For example, the AI/ML model may be a graph based visual saliency (GBVS) algorithm that determines locations or areas (portions of the image) of the UI 104 that draw the attention of an example operator. One example GBVS algorithm that may be employed is described in “Graph-Based Visual Saliency” by Jonathan Harel, Christof Koch, and Pietro Perona (which is hereby incorporated by reference in its entirety). In some examples, the GBVS algorithm can generate a map (e.g., a heat map or activation map where colors and/or shading are used to indicate a degree to which a person's vision is drawn to areas/regions of an image) that indicates key visual features in the image data and/or the diagram 114. In some examples, the GBVS algorithm can validate (e.g., check, confirm, etc.) the heat map with human eye-fixation data. In other examples, the AI/ML model may be a visual clutter analysis algorithm. For example, a visual clutter analysis algorithm may determine a first feature (e.g., a key feature such as an alarm condition of a first one of the component devices 110) and a second feature (e.g., visual clutter) in the image data. A first example visual clutter analysis algorithm includes a subband entropy measure that evaluates image coding efficiency and is described in “Measuring visual clutter” by Ruth Rosenholtz, Yuanzhen Li, and Lisa Nakano (which is incorporated by reference in its entirety). A second example visual clutter analysis algorithm is described in “Clutter Reduction Based on Coefficient of Variation in Through-Wall Radar Imaging” by Xi Chen and Weidong Chen (which is incorporated by reference in its entirety).

The example scoring circuitry 202 can assign a visual perception score to each feature. As such, the example scoring circuitry 202 can assign a first visual perception score to the first feature (the first one of the component devices 110) and a second visual perception score to the second feature (the output value associated with the first one of the component devices 110). In some examples, the scoring circuitry 202 can determine whether the first visual perception score is greater than, less than, or equal to the second visual perception score. In other examples, the visual perception score(s) may be compared to one or more predetermined threshold values associated with desired levels of visual perception. For example, one or more threshold values may be associated with a minimum desired visual perception of an alarm condition or other critical condition to which an operator's attention is to be drawn. Further, the example scoring circuitry 202 can determine a visual perception score for the feature based on identifying information (e.g., operating conditions, alarm conditions, etc.) associated with the feature. In some examples, the scoring circuitry 202 is instantiated by programmable circuitry executing scoring instructions and/or configured to perform operations such as those represented by the flowchart of FIG. 7.

In some examples, the interface circuitry 102 includes means for scoring a feature. For example, the means for scoring may be implemented by scoring circuitry 202. In some examples, the scoring circuitry 202 may be instantiated by programmable circuitry such as the example programmable circuitry 812 of FIG. 8. For instance, the scoring circuitry 202 may be instantiated by the example microprocessor 900 of FIG. 9 executing machine executable instructions such as those implemented by at least blocks 706, 708, 710 of FIG. 7. In some examples, scoring circuitry 202 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the scoring circuitry 202 may be instantiated by any other combination of hardware, software, and/or firmware. For example, the scoring circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example characteristic determination circuitry 204 determines a third example visual characteristic associated with the first feature based on a comparison of the first visual perception score and the second visual perception score. For example, if the visual perception score of the first feature is greater than the visual perception score of the second feature, then the characteristic determination circuitry 204 determines a third visual characteristic of the first feature different from the first visual characteristic. In some examples, the characteristic determination circuitry 204 can determine the third visual characteristic of the first feature by changing at least one of the size of the first feature, the shape of the first feature, the color of the first feature, the position of the first feature, or the orientation of the first feature. In some examples, the characteristic determination circuitry 204 determines the third visual characteristic to change (e.g., increase, decrease, etc.) the first visual perception score of the first feature (relative to the second feature) in a second diagram. For example, the characteristic determination circuitry 204 can determine the third visual characteristic based on an activation of an alarm condition associated with the first feature and/or a change in an operating condition associated with the first feature. In other examples, the characteristic determination circuitry 204 can determine a third visual characteristic for the second feature to increase the second visual perception score to cause the second visual perception score to satisfy the threshold visual perception score (e.g., based on a user request to increase the second visual perception score). In some examples, the characteristic determination circuitry 204 is instantiated by programmable circuitry executing characteristic determination instructions and/or configured to perform operations such as those represented by the flowchart of FIG. 7.

In some examples, the interface circuitry 102 includes means for determining a visual characteristic. For example, the means for determining may be implemented by characteristic determination circuitry 204. In some examples, the characteristic determination circuitry 204 may be instantiated by programmable circuitry such as the example programmable circuitry 812 of FIG. 8. For instance, the characteristic determination circuitry 204 may be instantiated by the example microprocessor 900 of FIG. 9 executing machine executable instructions such as those implemented by at least block 712 of FIG. 7. In some examples, the characteristic determination circuitry 204 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the characteristic determination circuitry 204 may be instantiated by any other combination of hardware, software, and/or firmware. For example, the characteristic determination circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example generator circuitry 206 generates second image data corresponding to a second example diagram including the first and second features, the first feature having the third visual characteristic and the second feature having the second visual characteristic. In some examples, the generator circuitry 206 can generate the second diagram to include a third example feature (e.g., a third one of the component devices 110). For example, the accessing circuitry 200 can access a user request to include a feature to represent one of the component devices 110 in the second diagram, and the generator circuitry 206 can change the second diagram to include the third feature. In some examples, the generator circuitry 206 can generate the second image data to remove a feature (e.g., visual clutter) from the diagram to increase the visual perception score of the first feature. As such, the example generator circuitry 206 can modify the image data based on the visual perception scores to increase at least one of the visual perception scores. In other examples, the generator circuitry 206 can modify the image data based on a user preference, business conventions, business best practices, etc. For example, if there is a user preference to darken or bolden alarms in the image data, the generator circuitry 206 can automatically modify the image data to darken or bolden alarms. In some examples, the generator circuitry 206 is instantiated by programmable circuitry executing generating instructions and/or configured to perform operations such as those represented by the flowchart of FIG. 7.

In some examples, the interface circuitry 102 includes means for generating image data. For example, the means for generating may be implemented by generator circuitry 206. In some examples, the generator circuitry 206 may be instantiated by programmable circuitry such as the example programmable circuitry 812 of FIG. 8. For instance, the generator circuitry 206 may be instantiated by the example microprocessor 900 of FIG. 9 executing machine executable instructions such as those implemented by at least blocks 714, 718, 720 of FIG. 7. In some examples, generator circuitry 206 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the generator circuitry 206 may be instantiated by any other combination of hardware, software, and/or firmware. For example, the generator circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example transmitter circuitry 208 displays the second diagram via the UI. For example, the transmitter circuitry 208 transmits the second diagram to the workstation 108. As such, the transmitter circuitry 208 can display the second diagram via the UI 104. In some examples, the transmitter circuitry 208 is instantiated by programmable circuitry executing transmission instructions and/or configured to perform operations such as those represented by the flowchart of FIG. 7.

In some examples, the interface circuitry 102 includes means for transmitting a diagram. For example, the means for transmitting may be implemented by transmitter circuitry 208. In some examples, the transmitter circuitry 208 may be instantiated by programmable circuitry such as the example programmable circuitry 812 of FIG. 8. For instance, the transmitter circuitry 208 may be instantiated by the example microprocessor 900 of FIG. 9 executing machine executable instructions such as those implemented by at least blocks 718, 722 of FIG. 7. In some examples, the transmitter circuitry 208 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the transmitter circuitry 208 may be instantiated by any other combination of hardware, software, and/or firmware. For example, the transmitter circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example detection circuitry 210 can detect an example user input from the example UI. For example, the detection circuitry 210 can detect a user request to include a feature to represent one of the component devices 110 in the second diagram. Additionally, the example detection circuitry 210 can detect a user request to emphasize a feature in the second diagram. In other words, the example detection circuitry 210 can detect a user request to increase (e.g., improve, enhance, etc.) the visual perception score associated with at least one of the features in the second diagram. In other examples, the detection circuitry 210 can detect a user request to decrease (e.g., blur, soften, etc.) the visual perception score associated with at least one of the features in the second diagram. In some examples, the detection circuitry 210 can detect a user request to remove a feature from the second diagram. In some examples, the detection circuitry 210 is instantiated by programmable circuitry executing detecting instructions and/or configured to perform operations such as those represented by the flowchart of FIG. 7.

In some examples, the interface circuitry 102 includes means for detecting an input. For example, the means for detecting may be implemented by detection circuitry 210. In some examples, the detection circuitry 210 may be instantiated by programmable circuitry such as the example programmable circuitry 812 of FIG. 8. For instance, the detection circuitry 210 may be instantiated by the example microprocessor 900 of FIG. 9 executing machine executable instructions such as those implemented by FIG. 7. In some examples, the detection circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the detection circuitry 210 may be instantiated by any other combination of hardware, software, and/or firmware. For example, the detection circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

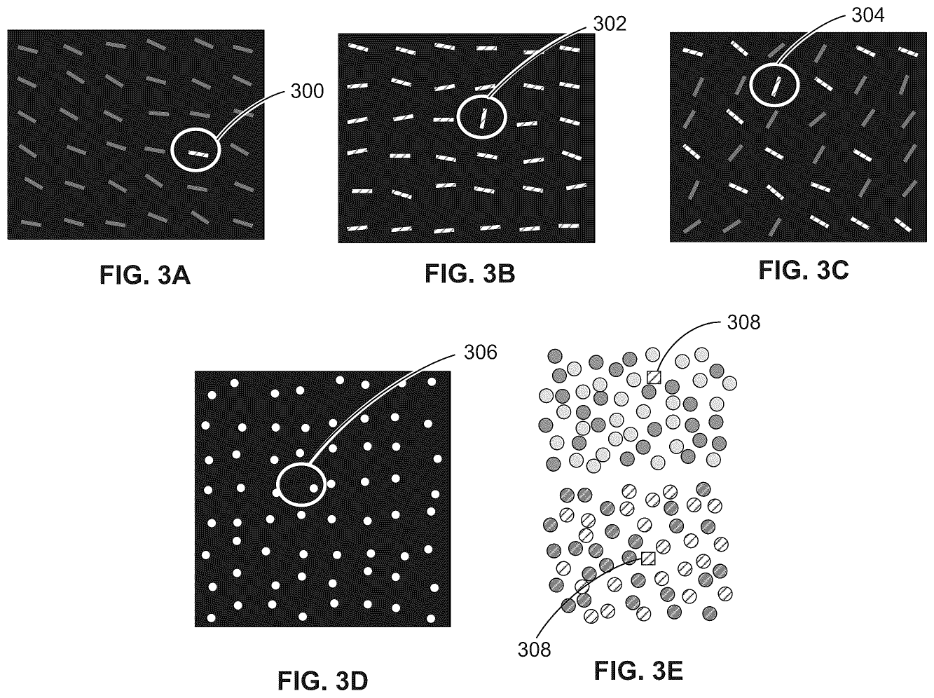

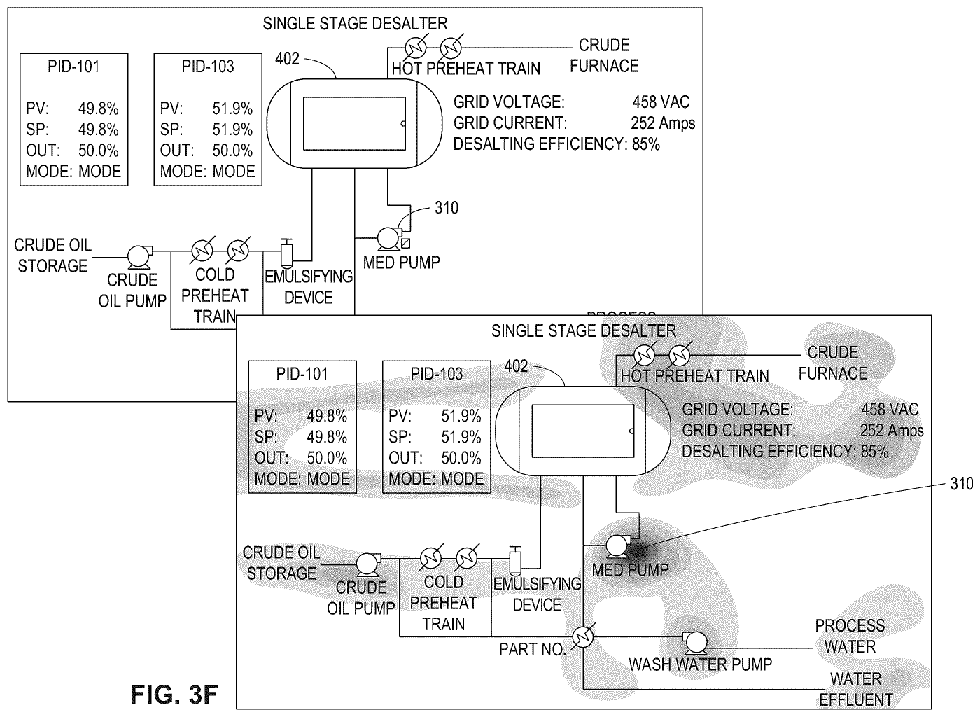

FIGS. 3A-3F illustrate example features having example visual characteristics determined by teachings disclosed herein. The example features of FIGS. 3A-3F may be detected (e.g., extracted, determined, etc.) by the GBVS algorithm described above in connection with FIG. 2. In the example of FIG. 3A, the GBVS algorithm can detect that example feature 300 includes at least one different visual characteristic (e.g., color) than other example features in FIG. 3A. As such, the scoring circuitry 202 may assign a visual perception score to the feature 300 that is greater than any visual perception score applied to the other features in FIG. 3A. Similarly, the GBVS algorithm can detect at least one different visual characteristic (e.g., orientation) of example feature 302 in FIG. 3B, at least two different visual characteristics (e.g., orientation and color) of example feature 304 in FIG. 3C, at least one different visual characteristic (e.g., movement, dynamic behavior, etc.) of example feature 306 in FIG. 3D, at least two different visual characteristics (e.g., color and shape) of example feature 308 in FIG. 3E, and at least two different visual characteristics (e.g., font and size) of example feature 310 in FIG. 3F. In the example of FIG. 3D, the example feature 306 may represent an item that is moving (e.g., on a conveyor belt) or flashing (e.g., increasing and decreasing in brightness) on the UI (e.g., the UI 104).

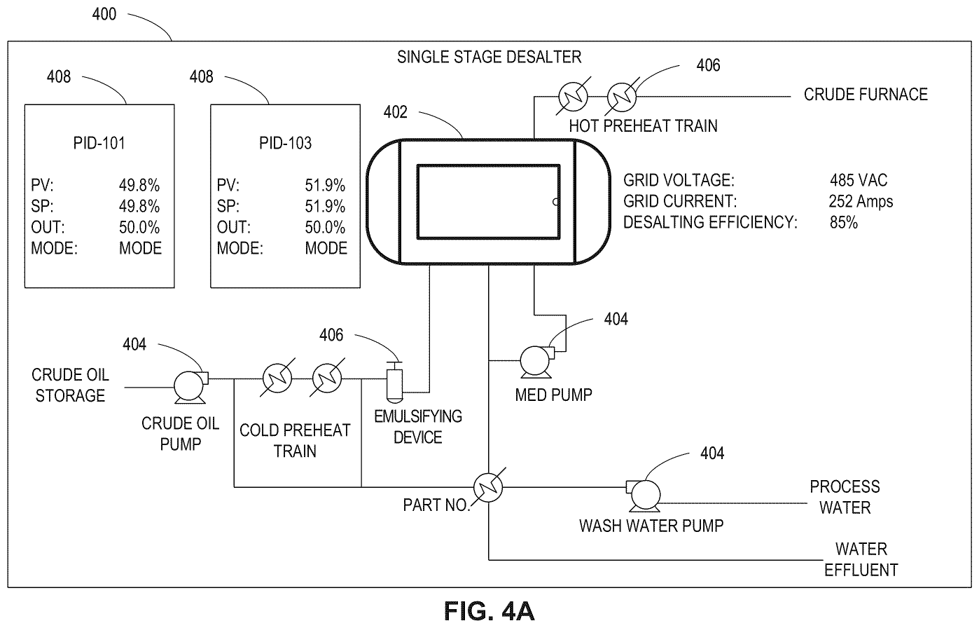

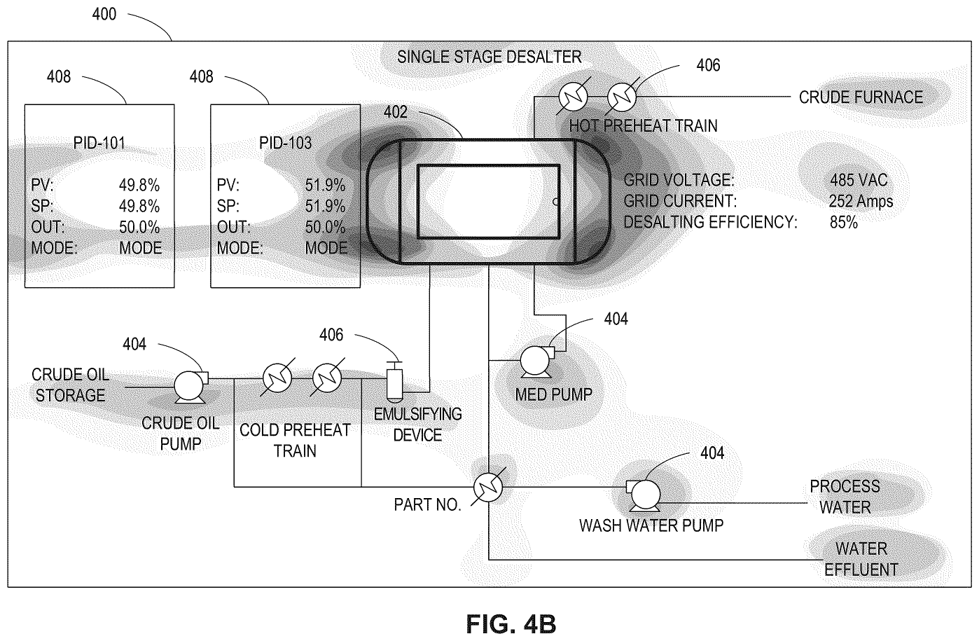

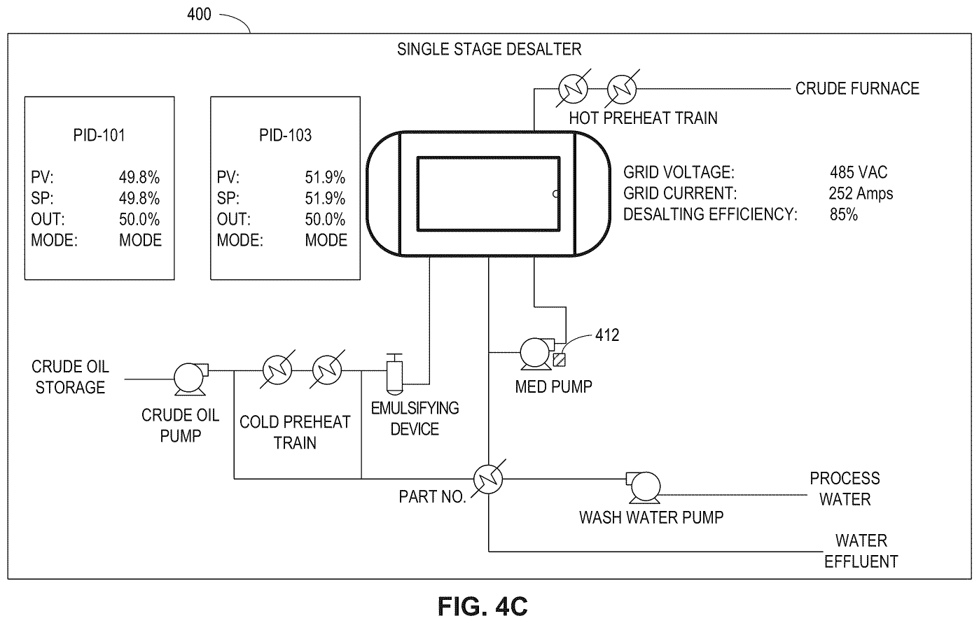

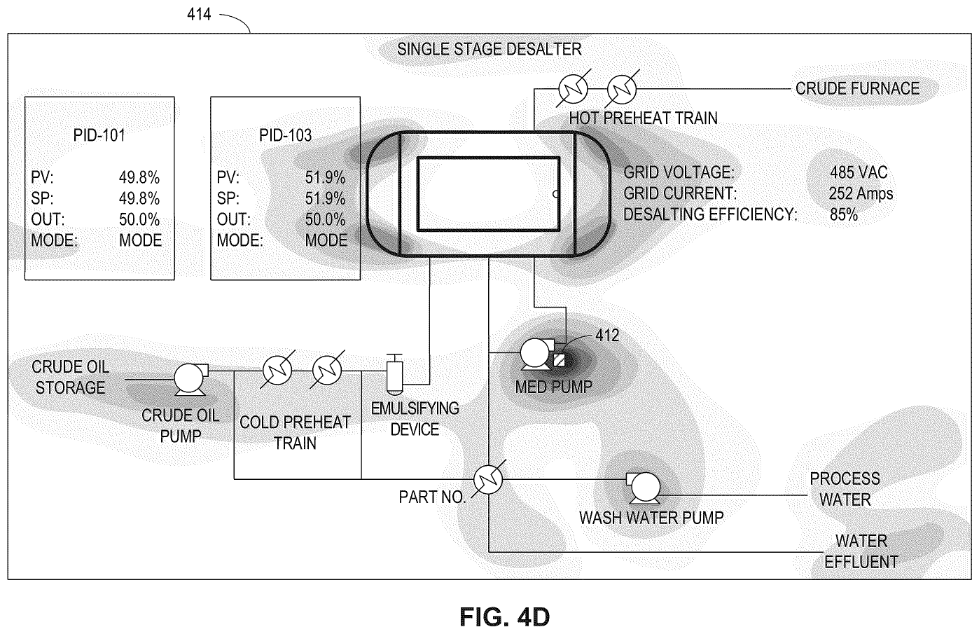

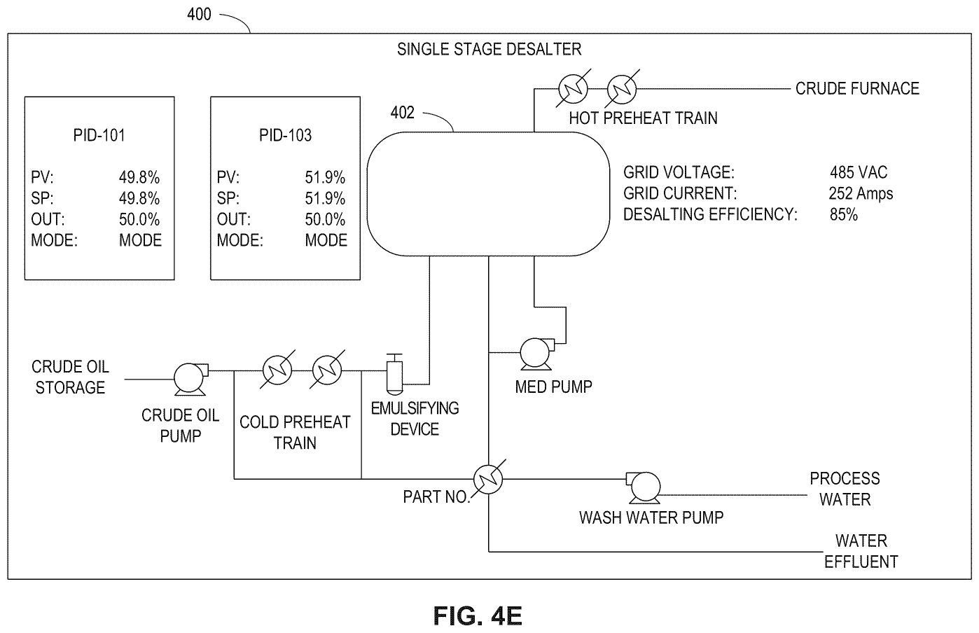

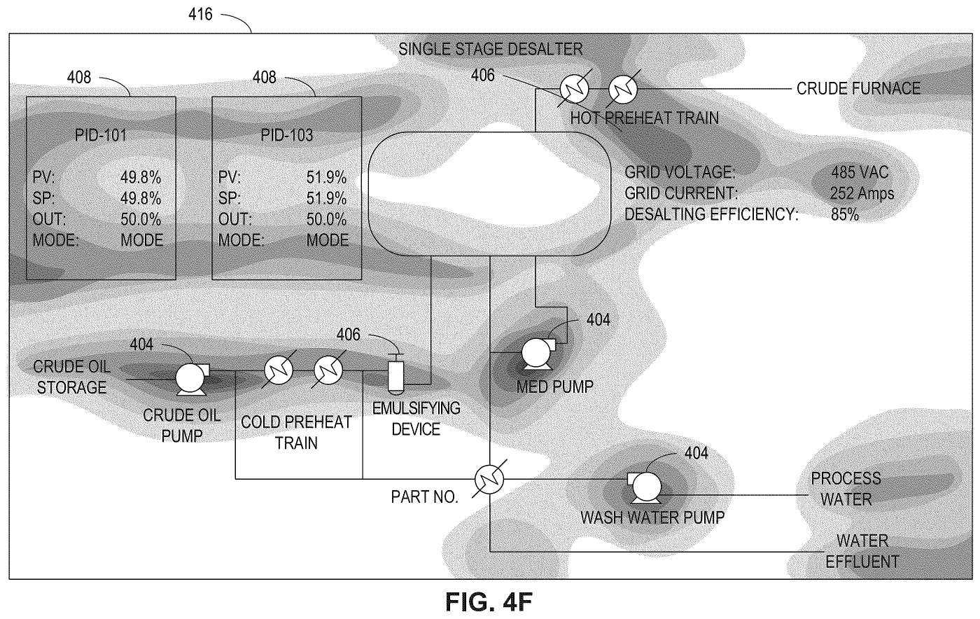

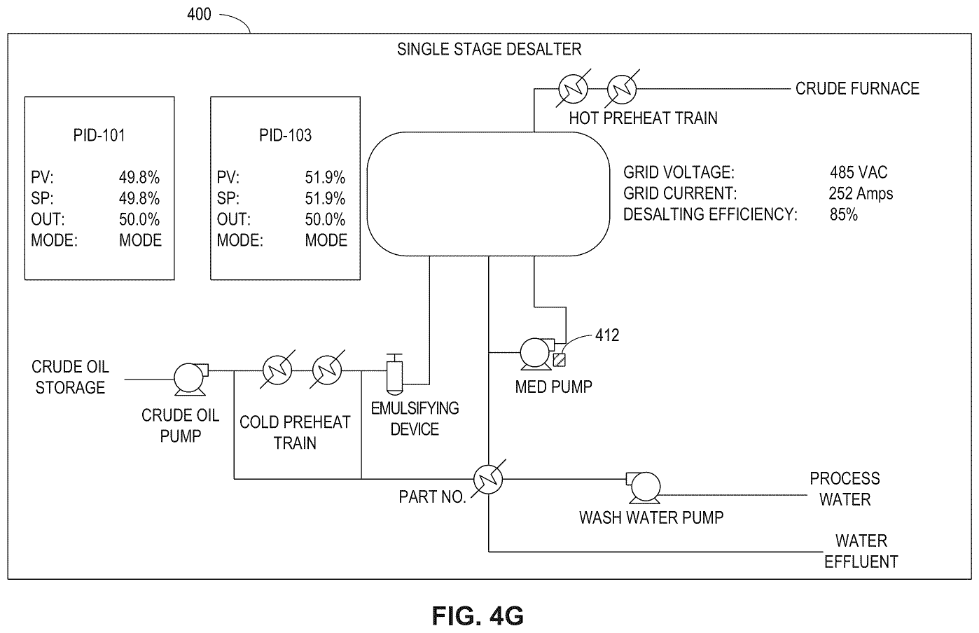

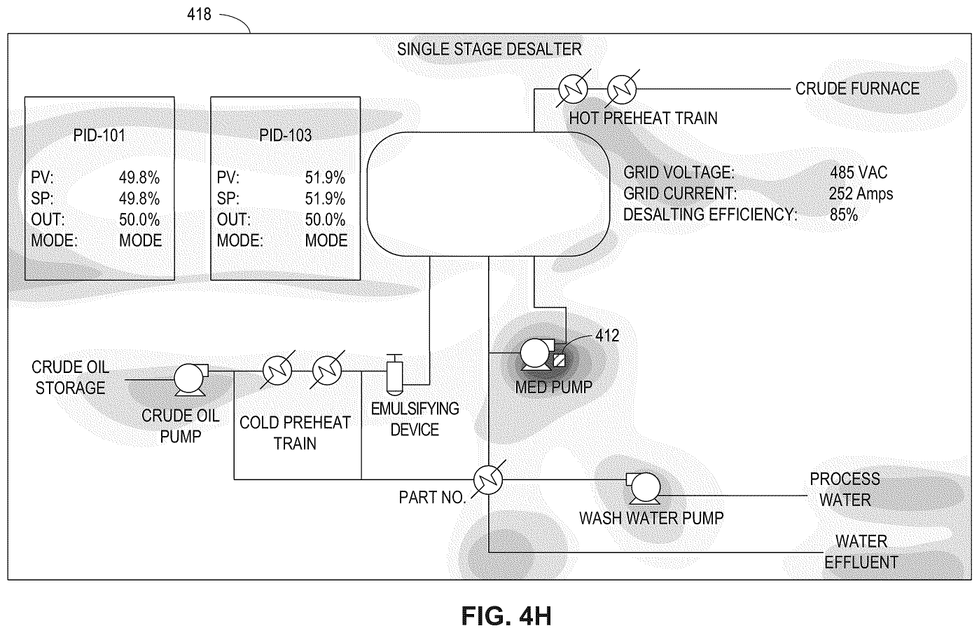

FIGS. 4A-4H illustrate example diagrams that can be implemented as the diagram 114 in the UI 104 of FIG. 1. Turning to FIG. 4A, the example accessing circuitry 200 can access example diagram 400 from the UI 104. The example diagram 400 includes features such as an example tank 402, example pumps 404, example devices 406, example tables 408, etc. The example GBVS algorithm can process the diagram 400 to generate example heat map 410 (FIG. 4B). The example heat map 410 illustrates significant areas that visually draw the attention of an example operator. For example, the corners of the tank 402 and the pumps 404 are emphasized in the heat map 410 due to the size, shape, color, etc., of the features in the diagram 400.

In FIG. 4C, the example generator circuitry 206 adds an example alarm 412 to the diagram 400. As shown in FIG. 4D, the GBVS algorithm can generate an example heat map 414 of the updated diagram 400 that emphasizes how the addition of the alarm 412 and/or the color of the alarm 412 can affect the attention of the example operator.

In FIG. 4E, the example generator circuitry 206 can modify the diagram 400 by changing at least one visual characteristic associated with the tank 402. As such, when the GBVS algorithm generates an example heat map 416 (FIG. 4F) of the diagram 400, the tank 402 is not a key feature in the heat map 416. Instead, the tables 408, the pumps 404, the devices 406, etc., are the distinguishing features of the diagram 400. As such, the example generator circuitry 206 can change a color of the tank 402 to match a color of the background such that the tank 402 does not distract the attention of the operator.

In FIG. 4G, the example alarm 412 is added to the diagram 400. When the GBVS algorithm generates an example heat map 418 (FIG. 4H) of the diagram 400, the distinct color of the alarm 412 is emphasized (as opposed to the similarly colored tank 402, pumps 404, devices 406, etc.). Accordingly, an example operator may be able to notice (e.g., read, look at, etc.) the alarm 412 quicker than in the diagram 400 as described in FIG. 4C.

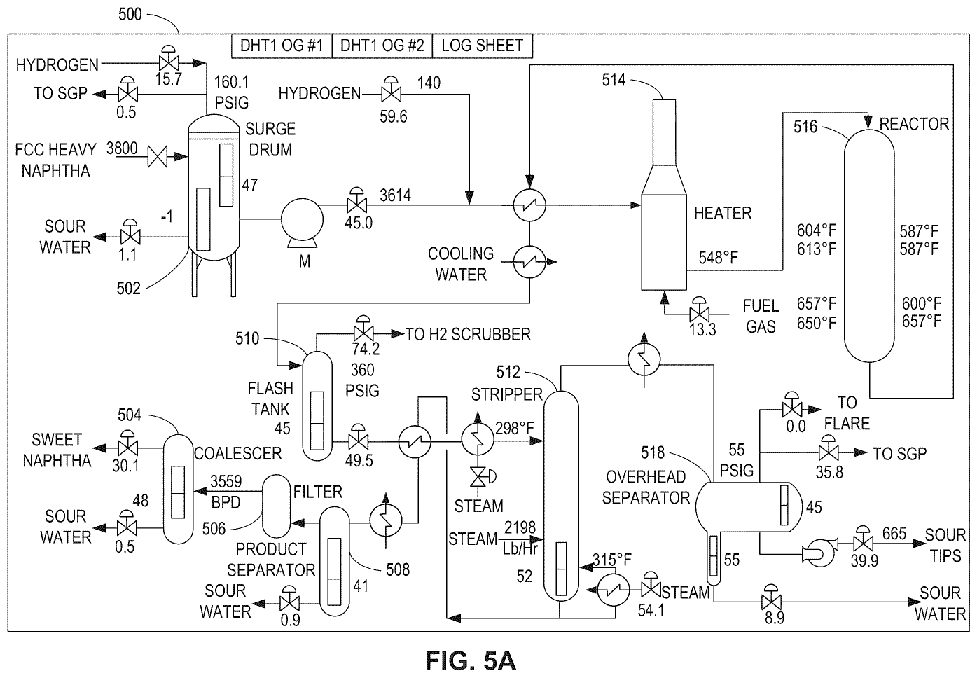

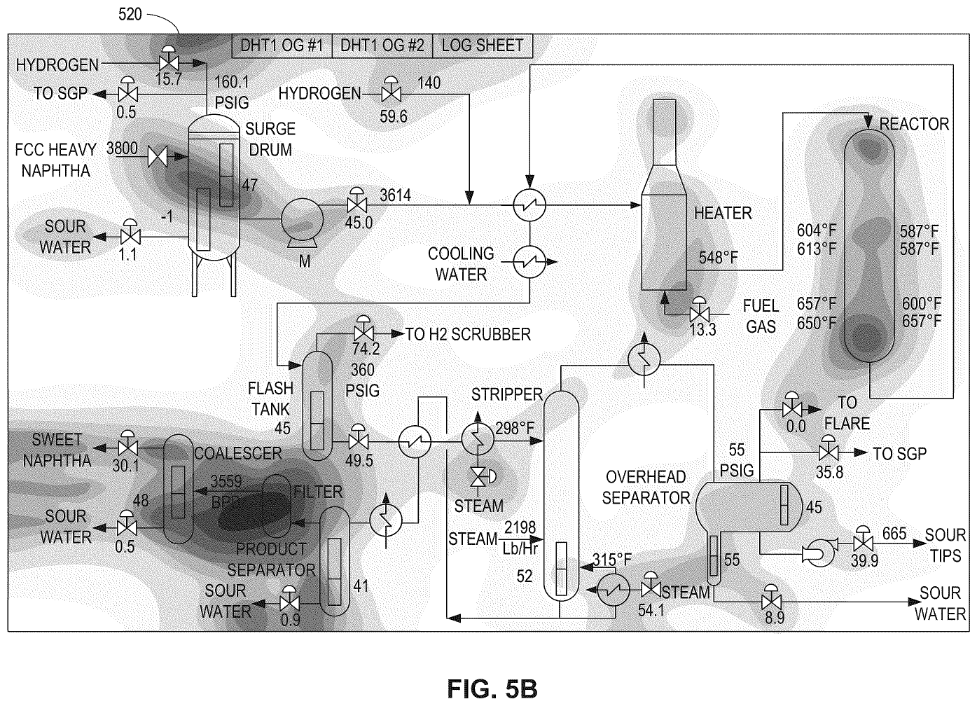

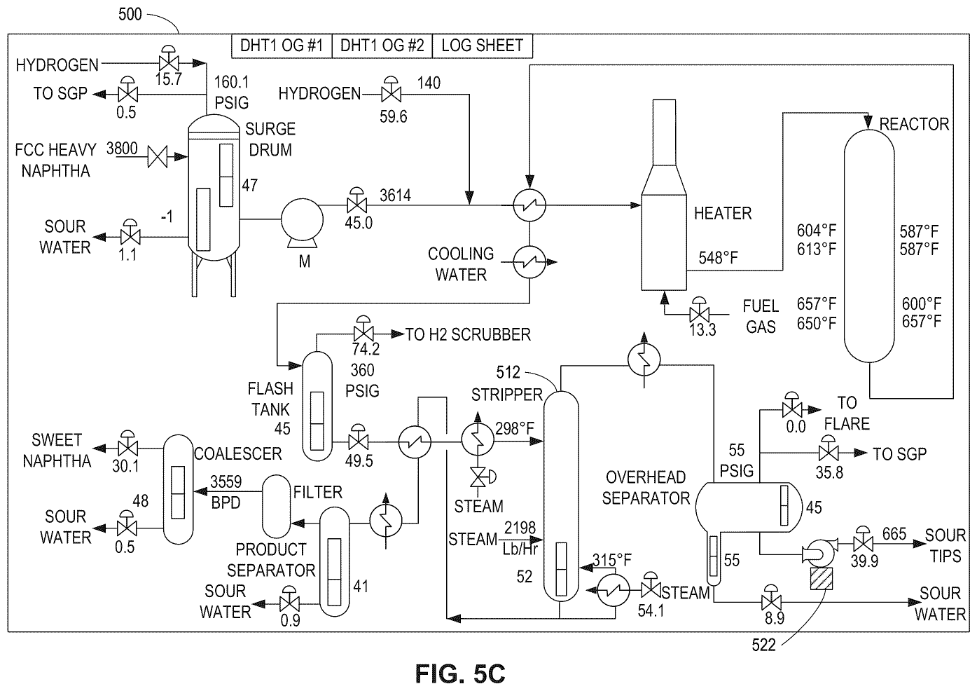

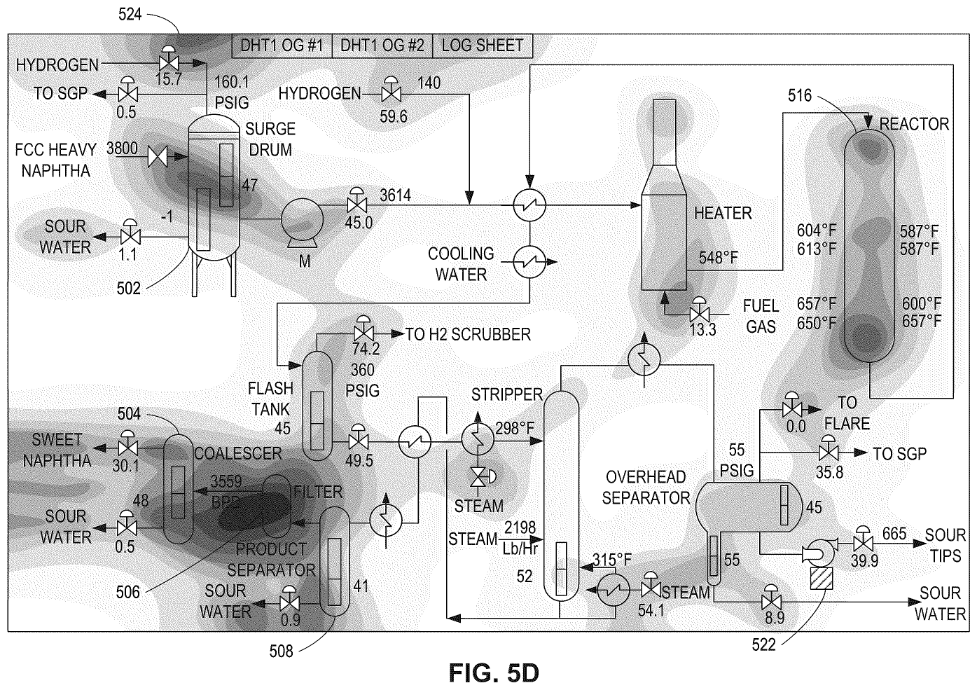

FIGS. 5A-5D illustrate example diagrams that can be implemented as the diagram 114 in FIG. 1. In FIG. 5A, example diagram 500 includes features 502, 504, 506, 508, 510, 512, 514, 516, 518 each having different colors (e.g., gray, green, pink, orange, yellow, red, etc.). An example heat map 520 (FIG. 5B), generated by an example GBVS algorithm, of the diagram 500 demonstrates that excessive use of color in such a diagram lacks organization and can distract an example operator. For example, when the example operator adds an example alarm 522 (FIG. 5C) to the diagram 500, an example heat map 524 may not emphasize the alarm 522 as a key feature for the operator to pay attention to. Rather, the focus of an example operator is directed to at least the features 502, 504, 506, 508, 516 (with the bolder colors). As such, the operator may need more time to notice the alarm 522. In some examples, the generator circuitry 206 can generate another diagram by changing (e.g., diluting, blurring, softening, etc.) the colors of at least the features 502, 504, 506, 508, 516 to enable the alarm 522 to be emphasized in the diagram. In other examples, the generator circuitry 206 can generate another diagram that may not include the features 502, 504, 506, 508, 516 to enable the alarm 522 to be emphasized in the diagram.

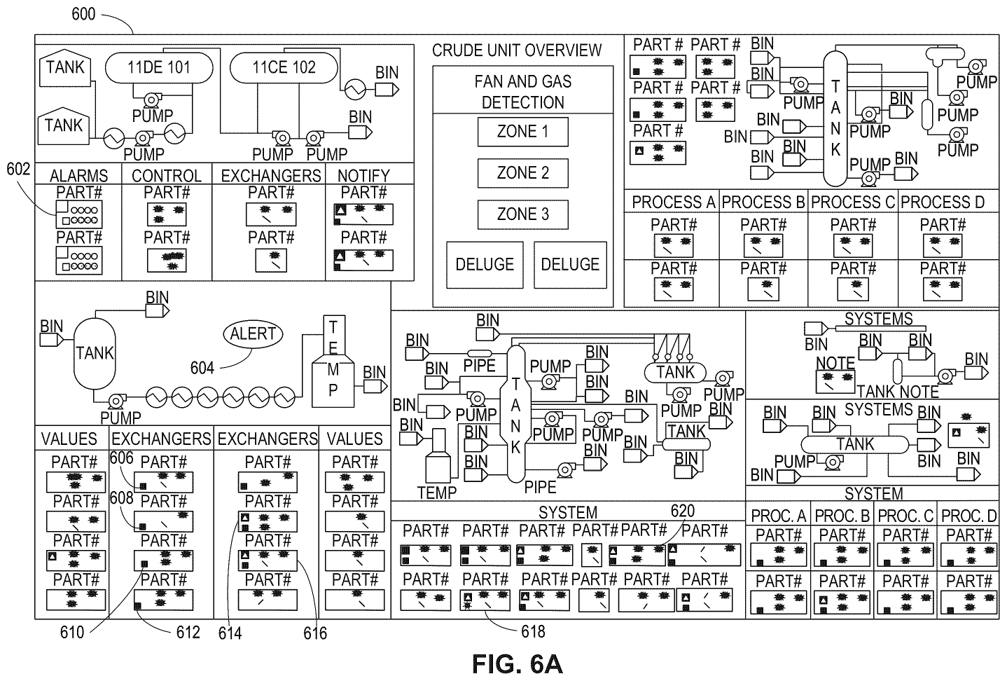

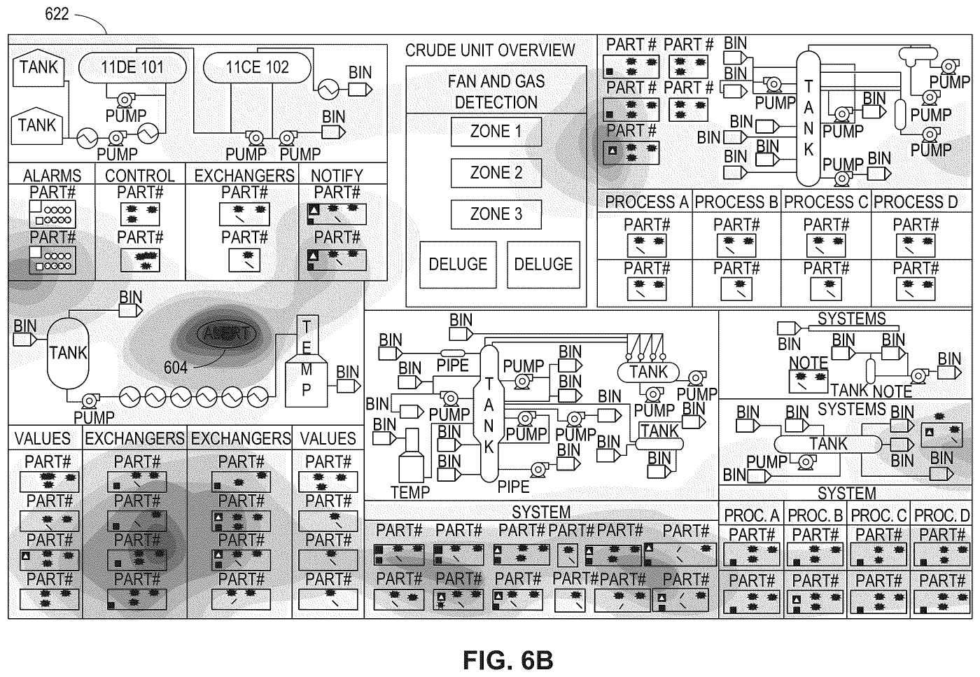

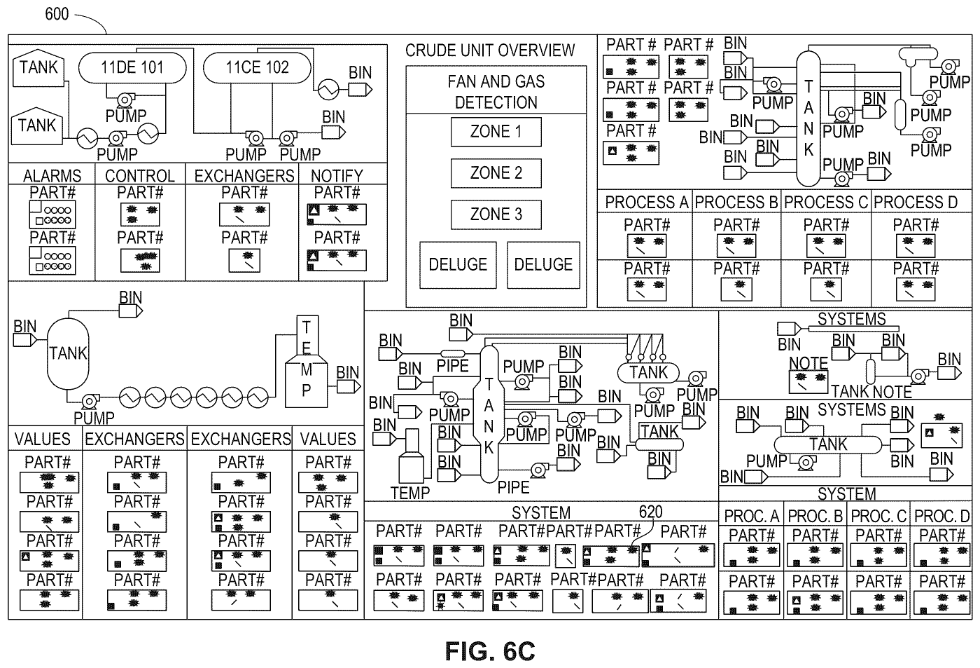

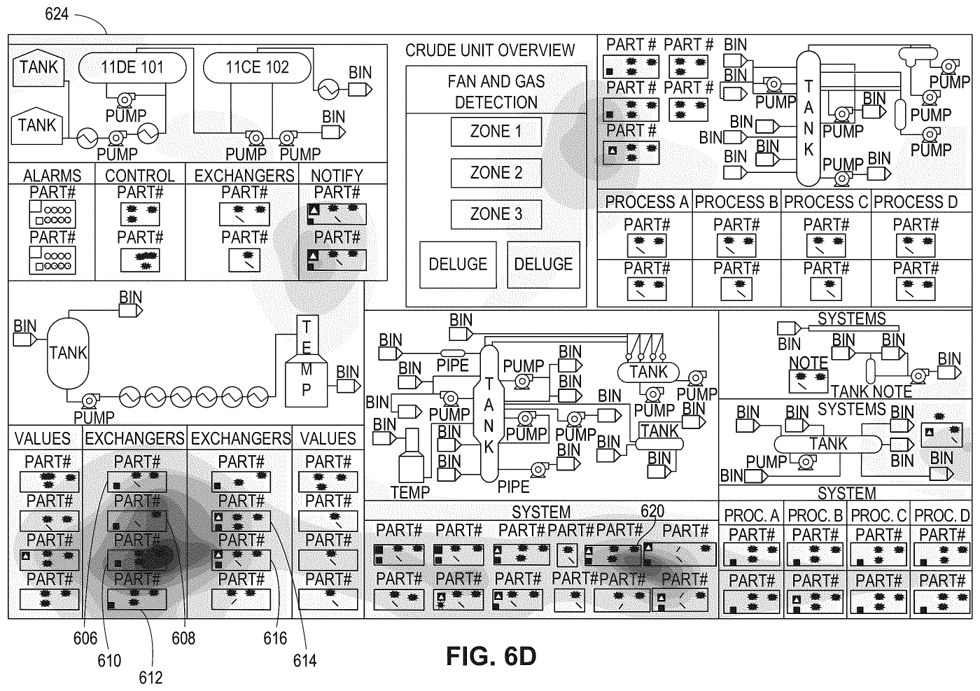

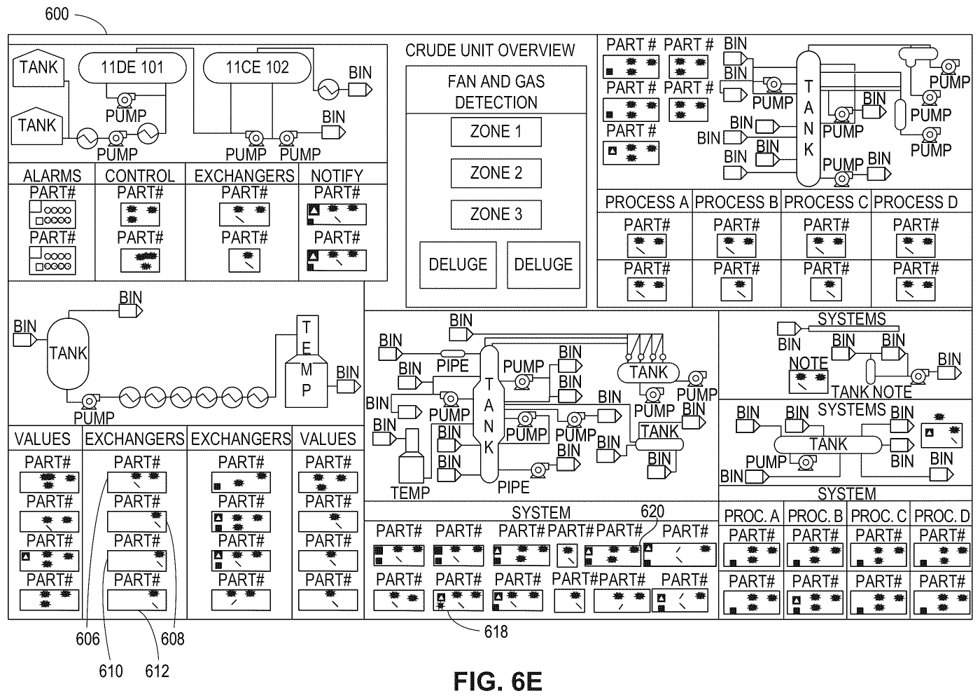

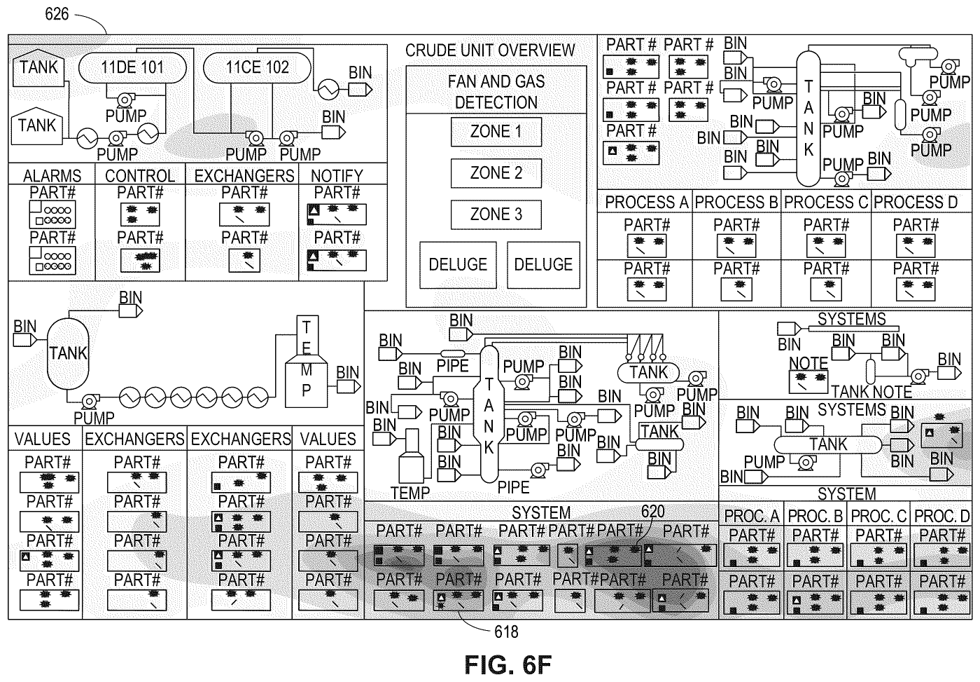

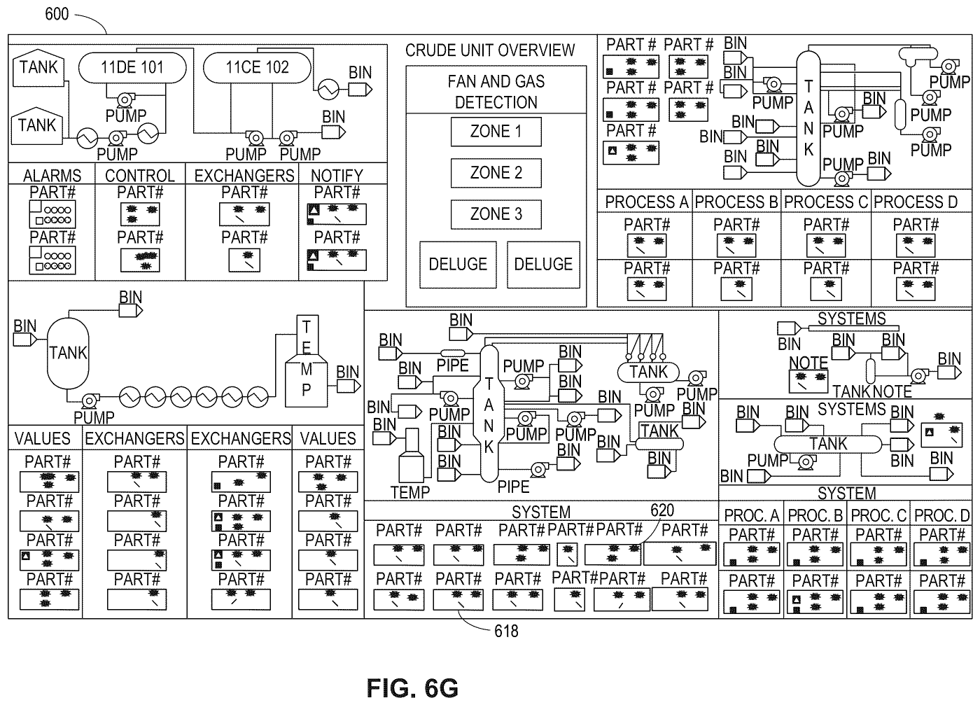

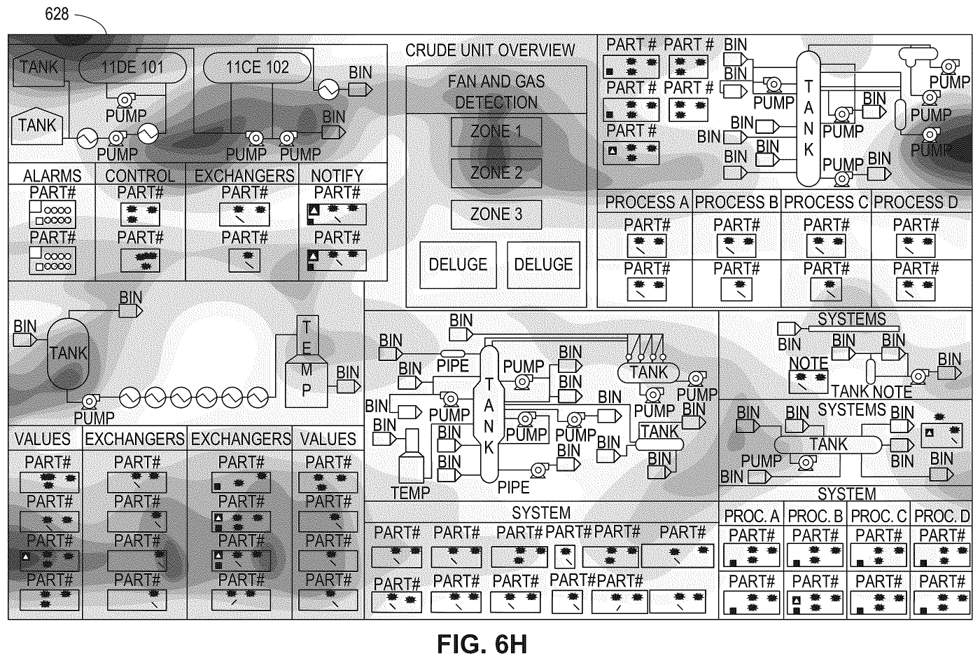

FIGS. 6A-6H illustrate example diagrams that can be implemented as the diagram 114 in FIG. 1. In FIG. 6A, example diagram 600 includes example features 602, 604, 606, 608, 610, 612, 614, 616, 618, 620 having colors (e.g., blue, yellow, red, black, etc.) different from the background color (e.g., gray). Thus, an example heat map 622 (FIG. 6B) of the diagram 600 (generated by an example GBVS algorithm) demonstrates that the feature 604 pulls the attention of an example operator due to the bold, unique red color of the feature 604. In FIG. 6C, the example generator circuitry 206 can remove the feature 604. Then, example heat map 624 (FIG. 6D) of the updated diagram 600 (generated by an example GBVS algorithm) illustrates that the attention of an example operator is directed toward at least the features 606, 608, 610, 612, 614, 616, 620.

In FIG. 6E, the example generator circuitry 206 can remove portions of the features 606, 608, 610, 612 in the diagram 600. Then, an example heat map 626 (FIG. 6F) of the updated diagram 600 (generated by an example GBVS algorithm) illustrates that the attention of an example operator is directed towards at least the features 618, 620. In FIG. 6G, the example generator circuitry 206 can modify the diagram 600 by changing at least one visual characteristic (e.g., color, shape, etc.) of the features 618, 620. As such, an example heat map 628 (FIG. 6H) (generated by an example GBVS algorithm) of the diagram 600 illustrates that the attention of an example operator may be dispersed (e.g., scattered) across the diagram 600 instead of focusing on more relevant features (e.g., alarms, notifications, predetermined conditions, state changes, etc.). In some examples, the diagrams in FIGS. 6A-6H demonstrate that the iterative removal of distractions (e.g., less relevant features, clutter, unnecessary information, etc.) can enable improve the organization and effectiveness of an example UI such as the UI 104.

While an example manner of implementing the interface circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example accessing circuitry 200, the example scoring circuitry 202, the example characteristic determination circuitry 204, the example generator circuitry 206, the example transmitter circuitry 208, the example detection circuitry 210, and/or, more generally, the example interface circuitry 102 of FIG. 2, may be implemented by hardware alone or by hardware in combination with software and/or firmware. Thus, for example, any of the example accessing circuitry 200, the example scoring circuitry 202, the example characteristic determination circuitry 204, the example generator circuitry 206, the example transmitter circuitry 208, the example detection circuitry 210, and/or, more generally, the example interface circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example interface circuitry 102 of FIG. 2 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed by programmable circuitry to implement and/or instantiate the interface circuitry 102 of FIG. 2 and/or representative of example operations which may be performed by programmable circuitry to implement and/or instantiate the interface circuitry 102 of FIG. 2, are shown in FIG. 7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example interface circuitry 102 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to modify an example UI. In some examples, the example machine-readable instructions and/or the example operations 700 are performed during runtime operation of the process control system 106. The example machine-readable instructions and/or the example operations 700 of FIG. 7 begin at block 702, at which the example accessing circuitry 200 accesses first image data corresponding to a first diagram displayed via an example UI. For example, the accessing circuitry 200 accesses the first image data corresponding to the diagram 114 displayed via the UI 104. In some examples, the accessing circuitry 200 continuously obtains the image data during runtime operation of the process control system 106.

At block 704, the example accessing circuitry 200 identifies key features (such as a first feature and a second feature) in the first image data, the first feature having a first visual characteristic and the second feature having a second visual characteristic. In some examples, the accessing circuitry 200 identifies these key features to be visually emphasized for a user of the UI 104. The accessing circuitry 200 identifies the first feature (e.g., a first one of the component devices 110) having a first visual characteristic (red color) and a second feature (e.g., a second one of the component devices 110) having a second visual characteristic (gray color) in the first image data. In other examples, each of the first and second visual characteristics includes at least one of a size, a shape, a position, or an orientation of the corresponding first and second features. In some examples, the first feature represents a first one of the component devices 110 in the process control system 106 and the second feature represents an output value associated with the first one of the component devices 110. Alternatively, the first feature may represent an alarm condition or a predetermined condition. In some examples, the accessing circuitry 200 can determine identifying information (e.g., operating conditions, alarm conditions, etc.) associated with the first and second features.

At block 706, the example scoring circuitry 202 determines a first example visual perception score associated with the first feature. For example, the scoring circuitry 202 may be communicatively coupled to a GVBS algorithm that can generate an example heat map of the diagram 114. The example scoring circuitry 202 can access the heat map and determine a visual perception score for the first feature based on the heat map. In other examples, the scoring circuitry 202 may be communicatively coupled to a visual clutter analysis algorithm to determine the first visual perception score. In some examples, the scoring circuitry 202 can determine the first visual perception score based on identifying information associated with the first feature.

At block 708, the example scoring circuitry 202 determines a second example visual perception score associated with the second feature. For example, the scoring circuitry 202 may be communicatively coupled to a GVBS algorithm that can generate an example heat map of the diagram 114. The example scoring circuitry 202 can access the heat map and determine a visual perception score for the second feature based on the heat map. In other examples, the scoring circuitry 202 may be communicatively coupled to a visual clutter analysis algorithm to determine the second visual perception score. In some examples, the scoring circuitry 202 can determine the second visual perception score based on identifying information associated with the second feature.

At block 710, the example scoring circuitry 202 compares the first visual perception score to the second visual perception score. For example, the scoring circuitry 202 determines whether the first visual perception score is greater than the second visual perception score. In other examples, the scoring circuitry 202 compares the first visual perception score and the second visual perception score to an example threshold (e.g., a threshold visual perception score). In some examples, the scoring circuitry 202 can determine which of the features in the image data are key features based on visual perception scores that satisfy the threshold visual perception score. For example, the scoring circuitry 202 can determine that the second feature is an accessory feature when the second visual perception score exceeds (e.g., does not satisfy) the threshold visual perception score.

At block 712, the example characteristic determination circuitry 204 determines a third example visual characteristic for the first feature based on the comparison. For example, if the visual perception score of the first feature is greater than the visual perception score of the second feature, then the characteristic determination circuitry 204 determines a third example visual characteristic (green color) of the first feature different from the first visual characteristic (red color). Additionally, the characteristic determination circuitry 204 can determine a third visual characteristic for the first feature to increase the first visual perception score of the first feature relative to the second feature (e.g., in a second diagram). For example, the characteristic determination circuitry 204 can determine the third visual characteristic based on an activation of an alarm condition associated with the first feature and/or a change in an operating condition associated with the first feature. In other examples, the characteristic determination circuitry 204 can determine a third visual characteristic for the second feature to increase the second visual perception score to cause the second visual perception score to satisfy the threshold perception score (e.g., based on a user request to increase the second visual perception score detected via the detection circuitry 210). In other examples, the third visual characteristic corresponds to a change, via the characteristic determination circuitry 204, of at least one of the size of the first feature, the shape of the first feature, the position of the first feature, or the orientation of the first feature.

At block 714, the example generator circuitry 206 generates second image data corresponding to a second example diagram. For example, the generator circuitry 206 generates second image data corresponding to a second example diagram including the first and second features, the first feature having the third visual characteristic and the second feature having the second visual characteristic. In other examples, the generator circuitry 206 can generate the second image data to exclude or remove the second feature or any other feature to increase the first visual perception score of the first feature (or to reduce visual clutter).

At block 716, the example transmitter circuitry 208 displays the second diagram via the UI. For example, the transmitter circuitry 208 displays the second via the UI 104.

At block 718, the example generator circuitry 206 determines whether to add additional feature(s) to the second image data and the second diagram. For example, the generator circuitry 206 determines to add a third example feature to the second image data when the detection circuitry 210 detects an example user input from the UI 104. In such examples, the process proceeds to block 720. Otherwise, the process ends.

At block 720, the example generator circuitry 206 changes (e.g., modifies) the second diagram to include the additional feature(s). For example, the generator circuitry 206 changes the second diagram to include the third feature. In some examples, the third feature is associated with a third visual perception score greater than the second visual perception score.

At block 722, the transmitter circuitry 208 displays the second diagram to the UI. For example, the transmitter circuitry 208 displays the second diagram (e.g., the updated second diagram) to the UI 104. Then, the process ends.

FIG. 8 is a block diagram of an example programmable circuitry platform 800 structured to execute and/or instantiate the example machine-readable instructions and/or the example operations of FIG. 7 to implement the interface circuitry 102 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example accessing circuitry 200, the example scoring circuitry 202, the example characteristic determination circuitry 204, the example generator circuitry 206, the example transmitter circuitry 208, and the example detection circuitry 210.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 7. As such, the FPGA circuitry 1000 may be configured and/or structured to effectively instantiate some or all of the operations/functions corresponding to the machine readable instructions of the flowchart of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

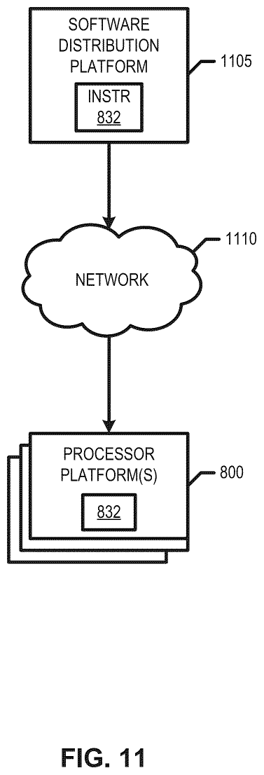

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIG. 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 7, may be downloaded to the example programmable circuitry platform 800, which is to execute the machine readable instructions 832 to implement the interface circuitry 102. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that employ Artificial Intelligence (AI)/Machine Learning (ML) models to categorize key features of an example image displayed on a user interface of a process control system. Examples disclosed herein monitor and/or otherwise process one or more images to be displayed via a UI to distinguish key features from accessory features and, subsequently, generate a one or more modified images that visually emphasizes the key features to which an operator's attention is to be drawn. As such, examples disclosed herein provide an operator of a UI of the process control system with a straightforward representation of the process control system. Further, examples disclosed herein enable an operator to promptly respond to system abnormalities and alarms. Disclosed systems, apparatus, articles of manufacture, and methods improve the efficiency of using a computing device by reducing clutter and other distracting features from a UI. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine readable instructions, and programmable circuitry to at least one of instantiate or execute the machine readable instructions to access first image data corresponding to a first diagram representing a process control system, the first diagram to be displayed via a user interface of the process control system, the first diagram including a first feature having a first visual characteristic and a second feature having a second visual characteristic, process the first image data to determine a first visual perception score associated with the first feature and a second visual perception score associated with the second feature, determine a third visual characteristic for the first feature, the third visual characteristic to increase the first visual perception score of the first feature relative to the second feature in a second diagram, generate second image data corresponding to the second diagram including the first and second features, the first feature having the third visual characteristic and the second feature having the second visual characteristic, and display the second diagram via the user interface.

Example 2 includes the apparatus of example 1, wherein each of the first and second visual characteristics includes at least one of a size, a shape, a color, a position, or an orientation of the corresponding first and second features.

Example 3 includes the apparatus of example 2, wherein the third visual characteristic corresponds to a change of at least one of the size of the first feature, the shape of the first feature, the color of the first feature, the position of the first feature, or the orientation of the first feature.

Example 4 includes the apparatus of example 1, wherein the first feature represents a process control device of the process control system and the second feature represents an output value associated with the process control device.

Example 5 includes the apparatus of example 1, wherein the programmable circuitry is to determine the first and second visual perception scores via a graph based visual saliency algorithm.

Example 6 includes the apparatus of example 1, wherein the programmable circuitry is to determine the first and second visual perception scores via a visual clutter analysis.

Example 7 includes the apparatus of example 1, wherein the programmable circuitry is to instantiate or execute the instructions to access a third feature to be included in the second diagram, the third feature having a third visual perception score greater than the second visual perception score, and change the second diagram to include the third feature.

Example 8 includes the apparatus of example 7, wherein the programmable circuitry is to instantiate or execute the instructions to detect a user input from the user interface, the user input including a request to include the third feature in the second diagram.

Example 9 includes the apparatus of example 1, wherein the first feature is associated with an alarm condition.

Example 10 includes the apparatus of example 1, the programmable circuitry is to instantiate or execute the instructions to generate the second image data to remove a third feature from the first diagram to increase the visual perception score of the first feature in the second diagram.

Example 11 includes the apparatus of example 1, wherein the programmable circuitry is to instantiate or execute the instructions to access the first image data, process the first image data, determine the third visual characteristic, generate the second image data, and display the second diagram via the user interface during runtime operation of the process control system.

Example 12 includes an apparatus comprising interface circuitry, machine readable instructions, and programmable circuitry to at least one of instantiate or execute the machine readable instructions to obtain image data of a user interface display for a process control system, identify key features of the image data to be visually emphasized for a user of the user interface display, determine a visual perception score for each of the key features based on at least one of a visual saliency algorithm or a clutter analysis, and modify the image data based on the visual perception scores to increase at least one of the visual perception scores.

Example 13 includes the apparatus of example 12, wherein the programmable circuitry is to continuously obtain the image data during runtime operation of the process control system.

Example 14 includes the apparatus of example 12, wherein the visual perception score is based on at least one of a visual saliency algorithm or a clutter analysis.

Example 15 includes the apparatus of example 12, wherein at least one of the key features corresponds to an alarm condition or a predetermined condition.

Example 16 includes the apparatus of example 12, wherein the programmable circuitry is to modify the image data by changing at least one of a size, a shape, a position, a color, or an orientation of an image corresponding to at least one of the key features.

Example 17 includes the apparatus of example 12, wherein the programmable circuitry is to modify the image data by removing a portion of the image data from the modified image data to reduce visual clutter.

Example 18 includes the apparatus of example 12, wherein the visual perception scores are first visual perception scores, wherein the programmable circuitry is to identify the key features by identifying a plurality of features in the image data, determining second visual perception scores for each of the plurality of features, comparing the second visual perception scores to a threshold visual perception score, and determining the key features in the plurality of features based on ones of the second visual perception scores that satisfy the threshold visual perception score.

Example 19 includes the apparatus of example 18, wherein the ones of the second visual perception scores are first ones of the second visual perception scores, wherein the programmable circuitry is to determine accessory features based on second ones of the visual perception scores that exceed the threshold visual perception score, the accessory features different from the key features.

Example 20 includes the apparatus of example 19, wherein the programmable circuitry is to detect a user request to increase at least one of the second ones of the visual perception scores to cause the at least one of the second ones of the visual perception scores to satisfy the threshold visual perception score.

Example 21 includes an apparatus comprising interface circuitry, machine readable instructions, and programmable circuitry to at least one of instantiate or execute the machine readable instructions to access first image data corresponding to a first diagram representing a process control system, the first diagram to be displayed via a user interface of the process control system, the first diagram including a feature having a first visual characteristic, determine identifying information associated with the feature, determine a visual perception score for the feature based on the identifying information, determine a second visual characteristic associated with the feature, the second visual characteristic to change the visual perception score in a second diagram, generate second image data corresponding to the second diagram including the feature, the feature having the second visual characteristic in the second diagram, and display the second diagram via the user interface.

Example 22 includes the apparatus of example 21, wherein the identifying information includes an operating condition associated with the feature or an alarm condition associated with the feature.

Example 23 includes the apparatus of example 22, wherein the programmable circuitry is to identify an activation of the alarm condition associated with the feature, and determine the second visual characteristic based on the activation of the alarm condition, the second visual characteristic to increase the visual perception score to satisfy a threshold visual perception score in the second diagram.

Example 24 includes the apparatus of example 22, wherein the programmable circuitry is to identify a change in the operating condition associated with the feature, and determine the second visual characteristic based on the change in the operating condition, the second visual characteristic to increase the visual perception score to satisfy a threshold visual perception score in the second diagram.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
access first image data corresponding to a first diagram representing a process control system, the first diagram to be displayed via a user interface of the process control system, the first diagram including a first feature having a first visual characteristic and a second feature having a second visual characteristic;
process the first image data to determine a first visual perception score associated with the first feature and a second visual perception score associated with the second feature;
determine a third visual characteristic for the first feature, the third visual characteristic to increase the first visual perception score of the first feature relative to the second feature in a second diagram;
generate second image data corresponding to the second diagram including the first and second features, the first feature having the third visual characteristic and the second feature having the second visual characteristic; and
display the second diagram via the user interface.

2. The apparatus of claim 1, wherein each of the first and second visual characteristics includes at least one of a size, a shape, a color, a position, or an orientation of the corresponding first and second features.

3. The apparatus of claim 2, wherein the third visual characteristic corresponds to a change of at least one of the size of the first feature, the shape of the first feature, the color of the first feature, the position of the first feature, or the orientation of the first feature.

4. The apparatus of claim 1, wherein the first feature represents a process control device of the process control system and the second feature represents an output value associated with the process control device.

5. The apparatus of claim 1, wherein the programmable circuitry is to determine the first and second visual perception scores via a graph based visual saliency algorithm.

6. The apparatus of claim 1, wherein the programmable circuitry is to determine the first and second visual perception scores via a visual clutter analysis.

7. The apparatus of claim 1, wherein the programmable circuitry is to instantiate or execute the instructions to:
access a third feature to be included in the second diagram, the third feature having a third visual perception score greater than the second visual perception score; and
change the second diagram to include the third feature.

8. The apparatus of claim 7, wherein the programmable circuitry is to instantiate or execute the instructions to detect a user input from the user interface, the user input including a request to include the third feature in the second diagram.

9. The apparatus of claim 1, wherein the first feature is associated with an alarm condition.

10. The apparatus of claim 1, the programmable circuitry is to instantiate or execute the instructions to generate the second image data to remove a third feature from the first diagram to increase the visual perception score of the first feature in the second diagram.

11. The apparatus of claim 1, wherein the programmable circuitry is to instantiate or execute the instructions to access the first image data, process the first image data, determine the third visual characteristic, generate the second image data, and display the second diagram via the user interface during runtime operation of the process control system.

12. An apparatus comprising:
interface circuitry;
machine readable instructions; and
programmable circuitry to at least one of instantiate or execute the machine readable instructions to:
obtain image data of a user interface display for a process control system;
identify key features of the image data to be visually emphasized for a user of the user interface display;
determine a visual perception score for each of the key features based on at least one of a visual saliency algorithm or a clutter analysis; and
modify the image data based on the visual perception scores to increase at least one of the visual perception scores.

13. The apparatus of claim 12, wherein the programmable circuitry is to continuously obtain the image data during runtime operation of the process control system.

14. The apparatus of claim 12, wherein the visual perception score is based on at least one of a visual saliency algorithm or a clutter analysis.

15. The apparatus of claim 12, wherein at least one of the key features corresponds to an alarm condition or a predetermined condition.

16. The apparatus of claim 12, wherein the programmable circuitry is to modify the image data by changing at least one of a size, a shape, a position, a color, or an orientation of an image corresponding to at least one of the key features.

17. The apparatus of claim 12, wherein the programmable circuitry is to modify the image data by removing a portion of the image data from the modified image data to reduce visual clutter.

18. The apparatus of claim 12, wherein the visual perception scores are first visual perception scores, wherein the programmable circuitry is to identify the key features by:
identifying a plurality of features in the image data;
determining second visual perception scores for each of the plurality of features;
comparing the second visual perception scores to a threshold visual perception score; and
determining the key features in the plurality of features based on ones of the second visual perception scores that satisfy the threshold visual perception score.

19. The apparatus of claim 18, wherein the ones of the second visual perception scores are first ones of the second visual perception scores, wherein the programmable circuitry is to determine accessory features based on second ones of the visual perception scores that exceed the threshold visual perception score, the accessory features different from the key features.

20. The apparatus of claim 19, wherein the programmable circuitry is to: detect a user request to increase at least one of the second ones of the visual perception scores to cause the at least one of the second ones of the visual perception scores to satisfy the threshold visual perception score.

21. An apparatus comprising:
interface circuitry;
machine readable instructions; and
programmable circuitry to at least one of instantiate or execute the machine readable instructions to:
access first image data corresponding to a first diagram representing a process control system, the first diagram to be displayed via a user interface of the process control system, the first diagram including a feature having a first visual characteristic;
determine identifying information associated with the feature;
determine a visual perception score associated with the feature based on the identifying information;
determine a second visual characteristic for the feature, the second visual characteristic to change the visual perception score in a second diagram;
generate second image data corresponding to the second diagram including the feature, the feature having the second visual characteristic in the second diagram; and
display the second diagram via the user interface.

22. The apparatus of claim 21, wherein the identifying information includes an operating condition associated with the feature or an alarm condition associated with the feature.

23. The apparatus of claim 22, wherein the programmable circuitry is to:
identify an activation of the alarm condition associated with the feature; and
determine the second visual characteristic based on the activation of the alarm condition, the second visual characteristic to increase the visual perception score to satisfy a threshold visual perception score in the second diagram.

24. The apparatus of claim 22, wherein the programmable circuitry is to:
identify a change in the operating condition associated with the feature; and
determine the second visual characteristic based on the change in the operating condition, the second visual characteristic to increase the visual perception score to satisfy a threshold visual perception score in the second diagram.
